(19) United States
(12) Patent Application Publication
(10) Pub. No.: US 2006/0197056 A1
(43) Pub. Date: Sep. 7, 2006

(54) Solvent-activated reactor using colloidal gel

(76) Inventor: Roy W. Martin, Downers Grove, IL (US)

Correspondence Address: DLA PIPER RUDNICK GRAY CARY US, LLP, 2000 UNIVERSITY AVENUE, E. PALO ALTO, CA, 94303-2248, US

(21) Appl. No.: 11/070,132

(22) Filed: Mar. 1, 2005

(51) Int. Cl. C01B 3/00

(52) U.S. Cl. 252/188.1

(57) ABSTRACT

A reactor for an in-situ production of a chemical product in high yield are presented. The reactor, which may be placed in a main solvent, includes an agglomerate of reactants and a binder layer around the reactants. The binder layer forms a colloidal gel wall when contacted by the main solvent (e.g., water), and the colloidal gel allows controlled permeation of the main solvent to the reactants. The reactants dissolve in the main solvent and react to produce a target product. The target product leaves the reactor through the colloidal gel wall at a controlled rate. A high concentration of the reactant is maintained in the chamber formed by the colloidal gel, resulting in a higher yield of the target product than if the reactants were directly added to a large body of main solvent.

### FIELD OF INVENTION

This invention relates generally to an oxidizing compound and more particularly to an oxidizing compound that is stabilized for storage.

### BACKGROUND

Oxidizers are commonly used to effectively destroy organic and inorganic contaminants. Some of the typical applications of oxidizers include treatment of water systems and inactivation of bacteria and viruses in various media.

Although oxidizers are used in numerous applications, there are also applications where they are not used even though their utility is well established. The reason these oxidizers are not used often relates to their instability during storage. Oxidizers such as hypochlorous acid and peracids, for example, could be used in more applications than the disinfection applications that they are already used in if their stability can be improved. The problem with some of these powerful oxidizers such as hypochlorous acid and peracids is that their activity level tends to decrease during storage. Since the effectiveness of the oxidizers in various applications depends on their concentrations, activity levels, and the level of demand on the oxidizer as measured by its oxidation reduction potential (ORP), a reduction in the activity level of the oxidizers impedes their performance in the various applications. Thus, even if an oxidizer is initially highly effective, the effectiveness decreases during storage.

A few methods are currently used to get around this storage problem. One of these methods, which is the point-of-use generation method or the in-situ method, is desirable because it eliminates the need for prolonged storage. However, on a practical level, these point-of-use generation methods are not widely employed because they require expensive equipment and specialized expertise. Other in-situ generation methods involve adding the reagents to the water to produce the target product. However, when doing this, significant dilution of reagents as well as competing reactions impede the level of conversion to the target product.

Sometimes, the reagents are coated to provide a protective shield or barrier between the reagents and the environmental elements, thereby making the reagents easier to store and use in formulations. The protective coatings are designed so that when they are combined with water, they dissolve and rapidly release the reagents. Silicates, for example, are widely used in laundry detergent applications. In the alkaline condition induced by the laundry formulation, the silicate coating rapidly dissociates and releases the encased additives into the bulk water. There are also instances where a highly hydrophobic coating such as a wax or slow-dissolving coating is used for time-release purposes. These cases operate on the basis of a mechanism similar to the mechanism of the silicate coating in that the outer coating material quickly dissolves to expose the enclosed material to the solvent in the environment.

Various compositions have been made to enhance the bleaching/oxidizing performance in an application. Such enhancement is desirable because the generally effective hydrogen peroxide donors such as percarbonate, perborate, and persulfate-based additives do not remove stubborn stains from clothing. To enhance their bleaching ability under the conditions that are typical to the application (e.g., laundry water), precursors are added to induce formation of a more effective bleaching agents (e.g., tetraacetyl-ethylenediamine (TAED)) in-situ. However, this addition of bleaching agent precursors has its disadvantages. For example, high concentrations of additives are needed to achieve effective results, increasing both the cost and inconvenience.

Another way of enhancing peroxygen compounds' performance is to make them more stable, thus allowing long-term storage. Sometimes, the peroxygen compounds and the formulations they are used in are coated to enhance storage stability. These coatings, however, do not always dissolve quickly and therefore increase the time it takes for the peroxygen compound to become effective. One of the ways to allow long-term storage of oxidizers such as potassium monopersulfate and chlorine is to store them in packages or bags. The packages or bags are designed to dissolve in water, so that they can be directly thrown into a body of water. Although the use of bags provides for easy application in large scale or macro applications, their utility is limited in that they can be used only for applications of a certain scale.

A method of stabilizing reactive components for storage without compromising or limiting their function during usage is desired.

### SUMMARY

In one aspect, the invention is a composition that generates and releases a target product at a controlled rate. The composition includes a reactant that is capable of generating the target product through a chemical reaction when contacted by a main solvent, and a binder material in contact with the reactant. The binder material, upon being exposed to the main solvent, forms a solvent-permeable colloidal gel wall that creates a chamber enclosing some of the reactant. The target product is generated in the chamber as the main solvent permeates in. The colloidal gel wall restricts the diffusion of the reactant and the target product out of the chamber, thus releasing the target product at a controlled rate. The colloidal gel wall disintegrates when a depletion level is reached inside the chamber. Different parts of the composition are exposed to the main solvent at different times.

In another aspect, the invention is a method of producing a composition that releases a target product at a controlled rate. There are more than one methods for producing such composition. In a first method, a reactant that generates the target product upon being contacted by a main solvent is combined with a binder to form a mixture. A pressure between about 1,000 psig and about 10,000 psig is applied to the mixture to form an agglomerate. In a second method, the reactants are mixed and formed into granules. The granules are then coated with a binder to form binder-coated granules. A pressure between about 1,000 and about 10,000 psig is applied to the binder-coated granules to create an agglomeration of the binder-coated granules.

In yet another aspect, the invention is a composition for generating and releasing chlorine dioxide at a controlled rate. The composition includes reactants such as a metal chlorite, an acid source, and optionally a free halogen source. The reactants generate a solution containing chlorine dioxide by a chemical reaction when dissolved in water. The composition also includes a binder material that, upon being contacted by water, forms a colloidal gel wall that creates a water-permeable chamber enclosing the reactants. The reactants dissolve and generate chlorine in the chamber. The colloidal gel wall restricts diffusion of the reactants and chlorine dioxide out of the chamber, and disintegrates when a depletion level is reached inside the chamber. Different parts of the composition contact the water at different times.

In yet another aspect, the invention is a composition for generating and releasing hydroxyl radicals at a controlled rate. The invention includes reactants such as a peroxide donor, an acid source, and a transition metal catalyst, and a binder material. The reactants generate hydroxyl radicals through a chemical reaction when contacted by water. The binder material, upon being contacted by water, forms a colloidal gel wall that creates a chamber enclosing the reactants such that hydroxyl radicals are generated in the chamber. The colloidal gel wall restricts diffusion of the reactants and the hydroxyl radicals out of the chamber, and disintegrates when a depletion level is reached inside the chamber.

### BRIEF DESCRIPTION OF THE DRAWINGS

FIG. 1 is an exemplary embodiment of reactor in accordance with the invention.

FIG. 2 is the reactor of FIG. 1 after the solvent interface has been exposed to the main solvent.

FIG. 3 is the reactor of FIG. 1 after the reactant concentrations inside the activated reaction chambers have reached the depletion level.

FIG. 4 shows the changes at the solvent interface for a first embodiment of the reactor.

FIG. 5 shows the changes at the solvent interface for a second embodiment of the reactor.

### DETAILED DESCRIPTION OF THE PREFERRED EMBODIMENT(S)

The invention is particularly applicable to generation and release of oxidizers that have bleaching, biocidal, or virucidal properties and it is in this context that the invention will be described. It will be appreciated, however, that the reactor, the method of making the reactor, and the method of using the reactor in accordance with the invention has greater utility and may be used for any other target product(s). Although the main solvent is described as water for clarity of illustration, the invention is not so limited.

“Reaction chamber” is a space that is defined by the outline of a colloidal gel wall, and includes the enclosed by the colloidal gel, the colloidal gel itself, and any pores or channels in the colloidal gel. A “main solvent,” is any solvent that dissolves the reactant(s) and triggers a chemical reaction. A “polymer,” as used herein, includes a copolymer. A substance that is transported at a “controlled rate” does not cross a physical boundary explosively all at once but gradually, over a desired period of time.

As used herein, “depletion level” indicates a predetermined concentration level of the reactant(s) and the target product in a reaction chamber. When a reaction chamber is contacted by water, a chemical reaction is triggered and the reactant(s) in the reaction chamber are converted to the desired target product. The target product then leaves the reactor chamber at a controlled rate. The depletion level may be defined by parameters other than reactant concentration that also indicate the rate of target product generation, such as the pH level or the concentrations of the target product or a byproduct.

When the reactor wall “disintegrates,” it could collapse due to a pressure difference between the inside and the outside of the reactor, dissolve in the main solvent, or come apart and dissipate due to forces applied by the movement in the main solvent. A membrane is a solid porous material. “Water,” as used herein, is not limited to pure water but can be an aqueous solution.

To maximize the yield in a chemical reaction, it is usually preferable to start with high concentrations of reactants because the molar concentrations of the reactants determine the rate of reaction and the subsequent product yield. Therefore, adding reactants to a large body of water to be treated is not an effective way to generate the desired product in-situ. Adding the reactants to the water lowers the reactant concentrations, and the resulting conversion of the reactants to the desired product(s) is generally poor. Another factor to be considered is the side reactions. When generating an agent in-situ, the oxidizer reactant is often consumed in reactions other than those desired for the in-situ production of the target product. Therefore, adding the reactants to the water to be treated results in more reagent requirements, longer reaction time and/or an overall decreased yield of the target product.

Furthermore, the chemical environment, such as pH, can adversely affect the in-situ production of the target product. For example, reactions that are acid catalyzed are not supported in alkaline conditions such as laundry wash water. By isolating the reactants and controlling the conditions inside the reactor, efficient generation of the target product(s) occurs regardless of the conditions external to the reactor.

When an oxidizer, such as potassium monopersulfate (PMPS), is added to water to convert sodium chloride to hypochlorous acid through a hypohalite reaction, the conversion or yield is dependent on the molar concentrations of the reactants. As described above, however, adding a given amount of reactants to a large volume of water yields poor conversion to the target product. Furthermore, potassium monopersulfate is highly reactive with organic chemical oxygen demand (COD). Thus, upon being exposed to the bulk solution, the PMPS reacts with the COD and further reduces the concentration of PMPS that is available to induce the hypohalite reaction.

The invention is based on the concept that a high yield can be maintained by controlling the rate at which the reactants are exposed to water. More specifically, if the reactants were first exposed to a small volume of water and allowed to react to generate the target product, a high yield of the target product can be obtained because the reactant concentrations will be high. Then, the target product can be exposed to a larger volume of water without compromising the yield. The rate at which the reactants are exposed to water has to be such that the target product is generated in high-yield before more water dilutes the reactants. The invention controls the reactants' exposure to water by coating the reactants with a material that allows water to seep in and reach the reactants at a controlled rate.

Depending on the embodiment, the invention may be a reactor that is stable enough for storage and useful for generating high yields of products in-situ, product including oxidizers, biocides, and/or virucidal agents. A “soluble” reactor has walls that dissolve in the main solvent after the reaction has progressed beyond a certain point (e.g, the depletion level has been reached). The soluble reactor is stable when dry. When mixed with a main solvent (e.g., water), however, the coating material that forms the outer wall of the soluble reactor allows the solvent to slowly seep into the reactor space, dissolve the reactant(s), and trigger a chemical reaction. The chemical reaction generates a target product. Since the concentrations of the reactants are high within the soluble reactor, a high yield of the target product is achieved inside the reactor. After the reactor space reaches the predetermined depletion level, the coating material disintegrates.

In some embodiments, the reactor of the invention is a “micro-reactor” having a diameter or width in the range of 10-2000 μm. However, the reactor is not limited to any size range. For example, the reactor may be large enough to be referred to as a pouch. A single reactor may be both a micro-reactor and a soluble reactor at the same time. Furthermore, a reactor may have a soluble wall and a non-soluble wall.

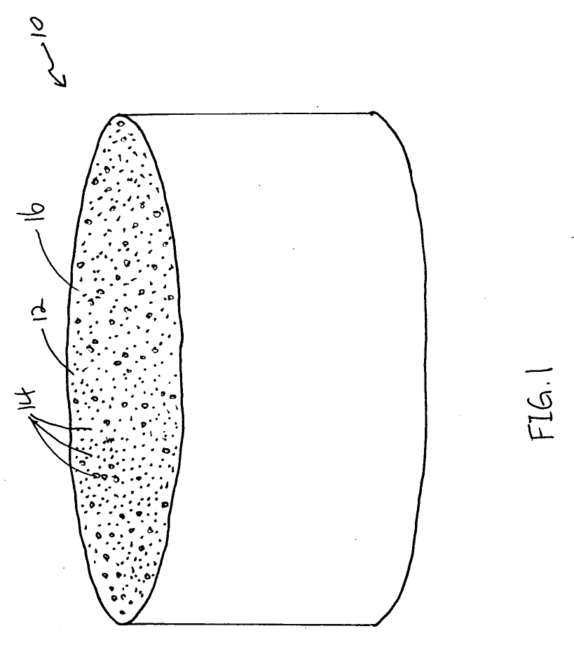

FIG. 1 is an exemplary embodiment of reactor 10 in accordance with the invention. Although the reactor 10 in this exemplary embodiment is cylindrically shaped, the invention is not so limited. The reactor 10 is an agglomerate composition containing one or more reactants 12 and a binder material 14. Although the reactants 12 and the binder material 14 are shown only for a solvent interface 16 of the reactor 10, they are preferably present throughout the reactor 10. The binder material 14 forms a colloidal gel when it comes in contact with the main solvent. Thus, when the reactor 10 is placed in contact with the main solvent, the binder material in the parts of the reactor 10 that come in contact with the main solvent will form walls of colloidal gel that divide the wet parts of the reactor 10 into multiple reactor chambers. The colloidal gel allows some permeation of the main solvent and other fluids across it, but in a restricted manner. Although only one interface 16 is shown in this example for simplicity of illustration, there may be multiple interfaces between the reactor 10 and the main solvent; in fact, the reactor 10 may be placed in a bulk body of main solvent.

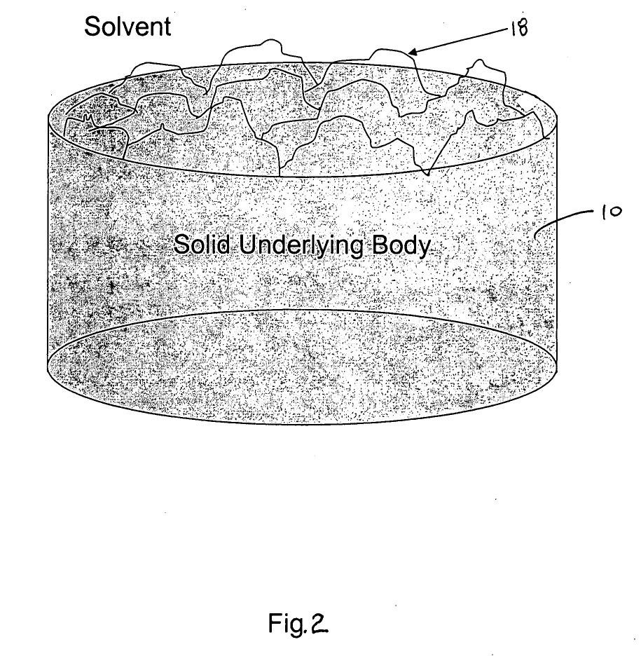

FIG. 2 is the reactor 10 after the solvent interface 16 has been exposed to the main solvent. As shown, colloidal gel 18 is formed at the interface between the main solvent and the reactor 10. The colloidal gel 18, which forms reaction chambers at the interface 16, restricts the diffusion of fluids across it. Thus, the environment inside of the reaction chambers is different from the bulk main solvent body outside the reactor 10. The environment inside the reactor 10 is more conducive to efficient target product generation than the bulk main solvent environment. While the colloidal gel walls form in parts of the reactor 10 that is in contact with the main solvent, the dry parts of the reactor 10 retain their original form.

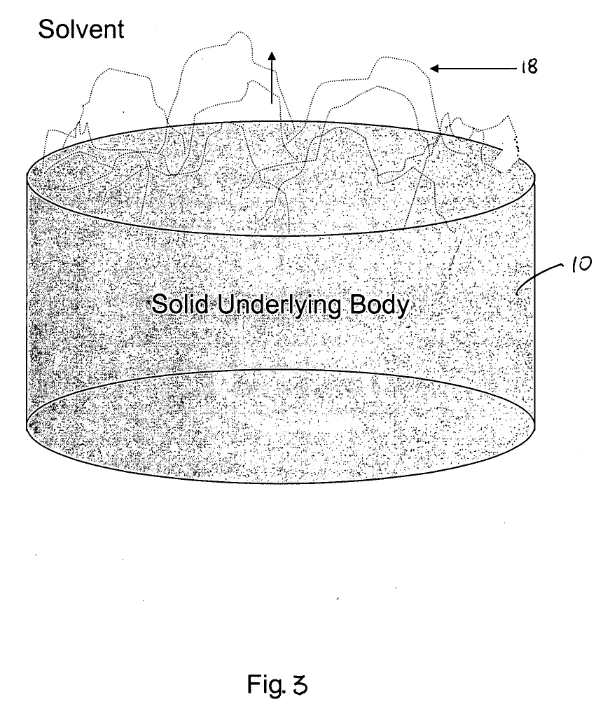

FIG. 3 is the reactor 10 after the reactant concentrations inside the activated reaction chambers have reached the depletion level. When the depletion level is reached, the colloidal gel walls 18 that form the reaction chambers begin to disintegrate, as shown with dotted lines to indicate the disappearance of the colloidal gel. The target product that was produced in the reaction chambers are released when the colloidal gel walls 18 disintegrate.

Since the colloidal gel walls prevent the main solvent from contacting the deeper portions of the reactor 10, the reactants 12 and the binder 14 underneath the interface 16 remain substantially dry while the first layer of colloidal gel reaction chambers are generating the target product. The disintegration of the colloidal gel walls 18, however, causes the layer of reactants and binder mixture that was under the colloidal gel layer to come in contact with the main solvent. This newly exposed part of the reactor 10 then contacts the main solvent, forms another set of colloidal gel walls, generates the target product, and releases the target product. The next level of reactants-and-binder mixture then comes in contact with the main solvent, and the generation and release of the target product continues as layers of the reactor 10 are “dissolved away” into the main solvent body.

The invention includes a method of preparing the reactor. The reactor produces high concentrations of one or more target products that are different from the reactants that are initially present in the reactor. The method of the invention allows the production of compositions that are stable for storage and, upon activation by contact with the solvent, produce a target product in a high yield. There are a few different methods for making the reactor 10 of the invention, and some of the different methods produce different embodiments.

One of the methods for preparing the reactor 10 entails mixing the reactants with binders and/or fillers and feeding the mixture to an agglomerating equipment. Once fed to the agglomerating equipment, a pressure of about 1,000 to about 10,000 psig is applied. The pressure makes the binder-reactant mixture agglomerate. The exact pressure to be applied is determined based on the final composition, the desired density of the resulting agglomerate, the desired dissolution rates, and the like. If desired, the agglomerate may be ground or crushed to achieve the desired particle size. The type and the amount of binders and/or fillers that is used depends on the desired size of the reactor and the oxidizing power. For example, a reactor having a lot of filler will have a weaker oxidizing power than a reactor of comparable size that is constituted mostly of reactants.

In an alternative method, the reactants are first mixed to form an agglomerate. There are various different ways to form the agglomerate. For example, a spray tower that is commonly used to agglomerate detergents, etc. may be used. This agglomerate can then be mixed with binders and/or fillers to be agglomerated (for the second time) into a tablet, etc. This way, the reactants are already agglomerated and the binder surrounds the reactants the reactants to form reaction chambers. In another example where the reactants, and binder, and/or the filler are all combined at once, the reactants may be separated and need to migrate before a reaction can take place.

The agglomerate of reactants (with or without binders) is granulated or crushed to form small pieces, or granules, containing the reactant mixture. If the agglomerate already has a binder layer surrounding them, the binder layer may be broken during the granulation/crushing process. However, the granules are again combined with the binder material to form a reactant-binder mixture, and a pressure between about 1,000 to about 10,000 psig is applied to the mixture to form the agglomerate composition.

Examples of equipment suitable for producing the agglomerate composition in the above methods include a compactor, an agglomerator, a roll compaction, a briquetting/tableting tool, an extruder, and the like. These suitable equipment is obtainable from Hosokawa Micron Corporation.

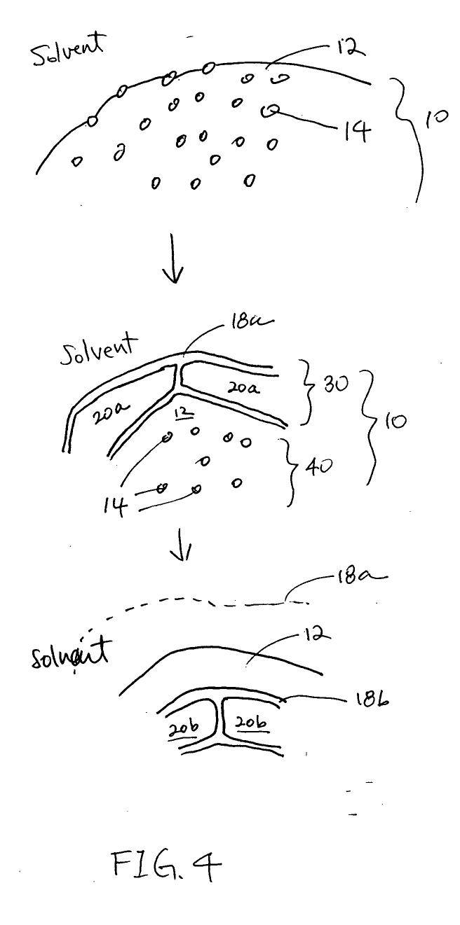

FIG. 4 shows the changes at the solvent interface 16 for a first embodiment. This first embodiment may be prepared by mixing the binder and the reactants before forming an agglomeration. As shown, a reactor 10 containing the reactants 12 and the binder material 14 in an agglomerated form are initially placed in contact with the main solvent. As the binder material 14 absorbs the solvent and swells up, first colloidal gel walls 18a form, creating first reaction chambers 20a. The reactants 12 usually include an oxidizer reactant, an oxidizable reactant, or both. The first colloidal gel walls 18a allows fluid permeation but in a restricted manner. Thus, while the reactants 12 dissolve in the permeated solvent and chemical reactions are generating the target product in the first chambers 20a, a section 40 of the reactor 10 retains its dry form. The target product that is generated in the first reaction chambers 20a leave the reaction chambers 20a at a controlled rate. Once the depletion level is reached, the colloidal gel walls 18a disintegrate and disappear, as shown by the dotted lines in FIG. 4. The disintegration of the colloidal gel walls 18a exposes a new part of the reactor 10 to the main solvent. If some of the reactants 12 are directly exposed to the solvent, they will dissolve and react to generate the target product, but this chemical reaction will not have a yield as high as if it had occurred under the sheltered environment of the colloidal gel reaction chambers. The binder material 14 absorbs the main solvent and forms a colloidal gel wall 18b, forming another set of reaction chambers 20b. Once the colloidal gel walls 18b are formed, the main solvent permeates into the reaction chamber 20b in a controlled manner. The reactants 12 in the chamber, activated by this main solvent, generate the target product and the target product is released at a controlled rate. When the depletion level is reached, the colloidal gel wall 18b disintegrates (not shown) and releases the generated target product into the bulk solvent body. Since only a portion of the reactor 10 generates the target product at a given time, a gradual time-release of the target product is achieved.

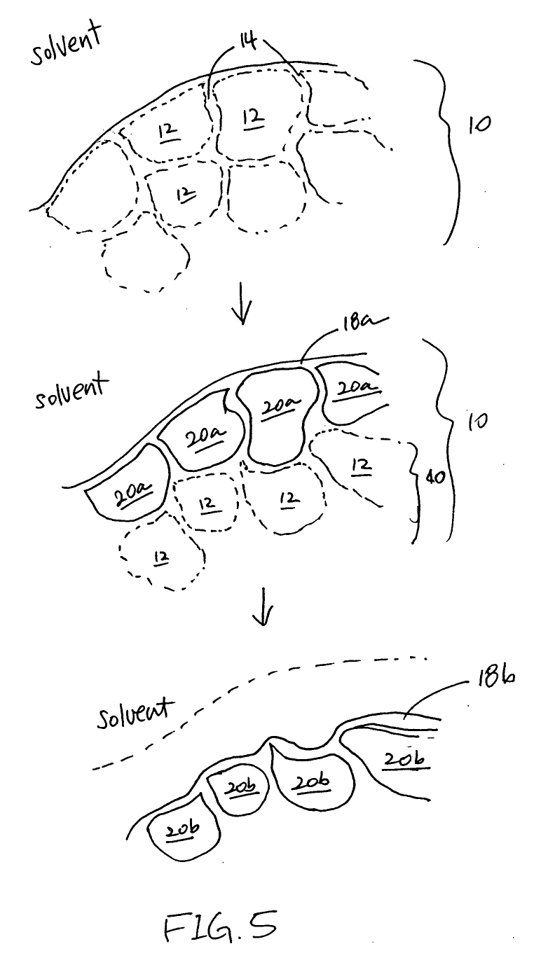

FIG. 5 shows the changes at the solvent interface 16 for a second embodiment. This second embodiment may be prepared by forming granules of reactants, coating and/or mixing the granules with binders, and applying pressure to agglomerate the binder-coated granules. As shown in FIG. 5, the outlines of the pre-agglomeration granules can be seen, defined by the binder material 14. When the reactor 10 is placed in contact with the solvent, colloidal gel walls 18a form near the outer areas of the reactor 10 where the binder material absorbs the solvent. The formation of the colloidal gel walls 18a creates first chambers 20a while the section 40 of the reactor 10 maintains its original form. The solvent continues to permeate through the colloidal gel walls 18a, dissolving the reactants 12 in the chambers 20a and triggering a chemical reaction that generates the target product. The target product permeates out of the chambers 20a, preferably in a solution form. Eventually, the first chambers 20a reach the depletion level and disintegrate, as shown by the broken line indicating the original outline of the reactor 10. When the first chambers 20a disintegrate, the solvent comes in contact with the next layer of reactants and binder material, and forms a second colloidal gel wall 18b. The second colloidal gel wall 18b forms a set of second chambers 20b, which then generate the target product.

One way to control the timing of the colloidal gel disintegration is to use a binder material so that the colloidal gel has a lower solubility than the reactants in the chamber.

Although the figures only show the reactants 12 and the binder material 14, there may be additional layers deposited on the reactor as indicated herein. For example, a protective coating layer such as one that contains a polymer, polysaccharide, polysioxane, polyvinyl alcohol, or silicate may be deposited on the outer surface of the reactor 10 to shield the reactor 10 from moisture, etc. during storage. Other components such as pH buffer and filler may also be used as desired, and they are described in detail below.

Generally, the reactants are broken down as about 1-90 wt. % oxidizer reactant and about 1-50 wt. % oxidizable reactant. The remainder of the body contains 20-90 wt. % binder and 0-40 wt. % pH buffer, with the remainder being fillers to achieve a total value of 100 wt. %.

Reactants

Reactants are selected to induce the formation of the desired product(s). When determining the ratio of reactants, consideration should be given to the desired ratio of products. Single species generation of agent is achieved with proper optimization of reagent ratios.

High conversion of reactants and good stability of products are achieved by adding stabilizers and/or pH buffering agents to the mixture of reactants. For example, to produce N-haloimides such as N-chlorosuccinimide, N-succinimide is added to a mixture containing PMPS and NaCl. Also, an organic acid (e.g., succinic acid) and/or inorganic acids (e.g., monosodium phosphate) may be applied to ensure that the pH of the reactant solution is within the desired range for maximum conversion to the haloimide.

The reaction chambers 20 contain reactants that, upon dissolution to form a liquid phase, induce the in-situ generation of the desired target product(s). For example, where the desired target product is a bleaching/oxidation agent, the reactant may be a peroxygen compound such as a persulfate, inorganic peroxide, alkyl peroxide, and aryl peroxide, or a free halogen such as dichloroisocyanuric acid, a salt of dichloroisocyanuric acid, a hydrated salt of dichloroisocyanuric acid, trichlorocyanuric acid, a salt of hypochlorous acid, bromochlorodimethylhydantoin and dibromodimethylhydantoin.

1) Dioxirane

Where the target product is dioxirane, the oxidizer reactant may be one of potassium persulfate, sodium persulfate, ammonium persulfate, potassium monopersulfate, permanganate, and a Caro's acid precursor. The Caro's acid precursor is a combination of a peroxide donor (e.g., urea peroxide, calcium peroxide, magnesium peroxide, sodium peroxide, potassium peroxide, perborate, perphosphate, persilicate, and percarbonate) and a sulfuric acid donor (e.g., sodium bisulfate and pyrosulfate and a sulfuric acid donor). In addition to the oxidizer reactant, the reactant 10 may also include an organic compound containing carbonyl groups (C═O) to produce dioxirane. Preferably, the organic compound has 3-20 carbons. The reactant composition may be 10-80 wt. % oxidant and 0.5-50 wt. % carbonyl donor such as aldehydes, ketones, and carboxylic acids. If a pH buffer is used, it does not exceed 30 wt. % of the pH buffer. Dioxirane formation is typically most efficient around neutral pH.

2) Percarboxylic Acid

Where the target product is a peroxycarboxylic acid (also referred to as percarboxylic acid), the reactants may include an oxidizer reactant such as urea peroxide, calcium peroxide, magnesium peroxide, sodium percarbonate, sodium perborate, persulfate(s), monopersulfate, persilicate, perphosphate, sodium peroxide, lithium peroxide, potassium peroxide, or permanganate. The reactants may also include a carboxylic acid donor such as an ester or acetic acid in the form of an anhydride (e.g., acetic anhydride). Another example is inclusion of tetraacetyl-ethylenediamine (TAED) with the peroxide donor for production of peracid in alkaline conditions. The overall reactant composition is about 10-80 wt. % oxidizer reactant and about 1-40 wt. % carboxyl group donor. Optionally, a filler and/or a pH buffer may be mixed with the reactants and the binder. The molar ratios are optimized and pH buffers may be added to the reactants. Upon dilution with water, the reactants dissolve and produce peracetic acid in high yield.

3) Hypohalite

Where the target product is a hypohalite, the reactants may include potassium persulfate, sodium persulfate, ammonium persulfate, potassium monopersulfate, permanganate, or a Caro's acid precursor. The Caro's acid precursor is a combination of a peroxide donor (urea peroxide, calcium peroxide, magnesium peroxide, sodium peroxide, potassium peroxide, perborate, perphosphate, persilicate, and percarbonate) and a sulfuric acid donor (sodium bisulfate and pyrosulfate). The reactants incude about 10-80 wt. % oxidizer reactant and about 0.5-40 wt.% halogen donor. Optionally, a binder, a filler, and a pH buffer may be added to the reactants.

4) N-halo-amide

Where the target product is an N-halo-amide, the reactant may be a potassium persulfate, sodium persulfate, ammonium persulfate, potassium monopersulfate, permanganate, or a Caro's acid precursor. The reactants may also include a monovalent metal salt, a divalent metal salt, or a trivalent metal salt, as well as an N-hydrogen donor capable of reacting with hypo-halite to generate the target product and a chlorite donor. The composition of the reactants is about 10-80 wt. % oxidizing reactant, 0.5-40 wt. % a halogen donor, and 2-50 wt. % stabilizer. Optionally, a binder, a filler, and a pH buffer may be added to the reactants.

5) Chlorine Dioxide

Where the target product is chlorine dioxide, the reactor composition is about 10-80 wt. % acid source, about 0.5-20 wt. % halogen donor, and about 0.5-15 wt. % chlorite donor. In one embodiment, the reactant may be potassium persulfate, sodium persulfate, ammonium persulfate, potassium monopersulfate, permanganate, or a Caro's acid precursor. The halogen donor may be, for example, magnesium chloride, calcium chloride, sodium chloride, or potassium chloride. The chlorite donor may be sodium chlorite, potassium chlorite, magnesium chlorite, or calcium chlorite, or various combinations thereof.

In another variation where the product is chlorine dioxide, the composition is about 10-60 wt. % oxidizing reactant (e.g., an acid source), about 0.5-40 wt. % free halogen donor, and about 1-50 wt. % metal chlorite. The reactant may be potassium monopersulfate, a metal bisulfate (e.g., sodium bisulfate), a metal pyrosulfate, or a metal phosphate. The halogen donor may be sodium chloride, calcium chloride, magnesium chloride, potassium chloride, dichloroisocyanuric acid, a salt of dichloroisocyanuric acid (e.g., a sodium salt thereof), a hydrated salt of dichloroisocyanuric acid, trichlorocyanuric acid, a salt of hypochlorous acid, bromochlorodimethylhydantoin, or dibromodimethylhydantoin. A sodium salt of dichloroisocyanuric acid dihydrate may also be used. The chlorite may be a mono- or di-valent chlorite such as sodium or calcium chlorite.

Another example of a chlorine dioxide generator contains sodium chlorite, sodium bisulfate, calcium/magnesium chloride, and the sodium salt of dichloroisocyanuric acid dihydrate. Free halogen donor is optionally incorporated into the reactor 10.

Where the reactants include a metal chlorite, an acid source, and a free halogen donor, the chemical reaction that occurs when the main solvent reaches the reactants generates an oxidizing solution containing chlorine dioxide and free halogen. The concentration of the free halogen in the oxidizing solution is less than ½ of the chlorine dioxide concentration in the oxidizing solution, preferably less than ¼ of the chlorine dioxide concentration in the oxidizing solution, and more preferably less than 1/10 of the chlorine dioxide concentration in the oxidizing solution. The ratio of the chlorine dioxide concentration to the sum of the chlorine dioxide concentration and chlorite anion concentration in such solution is at least 0.25:1, preferably at least 0.6:1, and more preferably at least 0.75:1 by weight. In some embodiments with a high free halogen content, the free halogen concentration in the oxidizing solution may be as high as 100 times the chlorine dioxide concentration. The ratio of the chlorine dioxide concentration to the sum of the chlorine dioxide concentration and chlorite anion concentration in such solution is at least 0.5:1 by weight.

In another embodiment, the reactant is urea peroxide, calcium peroxide, magnesium peroxide, sodium percarbonate sodium perborate, persulfate(s), monopersulfate, persilicate, perphosphate, sodium, lithium, or potassium peroxide. A halogen donor and a chlorate donor such as sodium chlorate, potassium chlorate, lithium chlorate, magnesium chlorate, and calcium chlorate may be included.

6) Hydroxyl Radical

Where the target product is a hydroxyl radical, the reactant composition may be about 10-80 wt. % reactants (e.g., peroxide donor and an acid source), about 0.001-10 wt. % a transition metal, and about 1-30 wt. % pH buffer. In addition, a binder and a filler may be used. The reactants may be urea peroxide, calcium peroxide, magnesium peroxide, sodium percarbonate sodium perborate, persulfate(s), monopersulfate, persilicate, perphosphate, sodium, lithium, permanganate, or potassium peroxide. The transition metal is a chelating agent selected from a group consisting of trisodium pyrophosphate, tetrasodium diphosphate, sodium hexametaphosphate, sodium trimetaphosphate, sodium tripolyphosphate, potassium tripolyphosphate, phosphonic acid, di-phosphonic acid compound, tri-phosphonic acid compound, a salt of a phosphonic acid compound, ethylene diamine-tetra-acetic acid, gluconate, or another ligand-forming compound.

Hydroxyl radical may be produced with a reactor that contains a metal catalyst. The metal catalyst may be mixed with the reactants, coated on the binder layer, or included in the reactor wall, for example in the pores on the membrane. The metal catalyst may be Cu (II), Mn (II), Co (II), Fe (II), Fe (III), Ni (II), Ti (IV), Mo (V), Mo (VI), W (VI), Ru (III), or Ru (IV). Upon dilution with water the composition releases peroxide. Under neutral to acidic conditions is converted to hydroxyl radicals upon reaction with the catalyst. The catalyst remains unaltered.

7) Singlet Oxygen

Where the target product is a singlet oxygen, peroxide salts such as calcium, magnesium, sodium peroxides, perborate, percarbonate, may be used as the reactant with a metal catalyst selected from transitional metals.

Binder Material

Binders are combined with the reactants to form a mixture. Binders, upon exposure to the main solvent, form a colloidal gel that is permeable to the main solvent. Examples of binder material include water-soluble silicates, aluminum sulfate, aluminates, polyaluminum chloride, polysaccharides including cellulose, chitosan and chitin, and absorbent polyacrylic polymers and copolymers such as Carbopol®. A poloxamer block copolymer such as Poloxamer 407 sold by BASF under the trade name Lutrol® F127, polyvinyl alcohol with or without borax, or polyacrylamides may also be used.

Silicates make effective binders for holding the reactants in place and restricting the release of reactants until the desired oxidant is produced. Silicate-based coating material may be something that contains silicate, such as metasilicate, borosilicate, and alkyl silicate. Under low-pH conditions, the silicates remain colloidal; however, when the acid-catalyzed conditions induced by the reactants is depleted, the colloid dissipates. Upon dissipating, various polysaccharides such as cellulose and chitosan form permeable gel barriers that can effectively function as reactor walls. Certain polymers such as water absorbent polyacrylates and their copolymers can also form gels. One example is Carbopol® sold by Noveon, Inc. located in Cleveland, Ohio.

How suitable a particular binder material is for a given application depends on the surrounding conditions. For example, silicate coatings are well established for providing a barrier film of protection to percarbonates and other bleaching agents used in laundry detergents but do not always make a reactor. In laundry detergents, the inclusion of bleach precursors such as tetraacetyl-ethylenediamine or nonanoyl-oxybenzene sulfonate to enhance the bleaching performance in low temperatures is common. The hydrolysis of the precursors requires alkaline pH conditions. In such applications, due to the hydrolysis requirements and peroxygen chemistry, the internal and external solution used to dissolve the reactants is high in pH. The silicate coating is soluble under alkaline conditions, and the integrity of the reactor wall is compromised. The coating dissociates rapidly, without acting as a reactor. In this case, the benefit of the high reaction yield is not achieved.

Silicates provide for a simple and inexpensive reactor coating when used in lower pH applications or formulations that result in internal acidic pH conditions that sustain the integrity of the reactor wall. This usefulness of silicates remains uncompromised even if the external conditions are alkaline in pH, such as in the case of laundry water. Silica solubility is poor at low pH. At lower pH, silica remains colloidal and forms a colloidal gel. When monopersulfate (MPS) and a source of chloride such as NaCl are encased within a coating of silicate such as sodium silicate, then added to water, the water permeates through fissures and cracks in the coating and dissolves the reactants. The resulting low pH (<5) from the dissolving MPS suppresses the dissolution rate of the surrounding silica, and the silica remains as a colloidal gel.

Inside the space enclosed by the silica gel barrier, the concentration of reactants remains high and the resulting reactions produce high yields of chlorine gas. Upon diffusion of the reactants and the chlorine into the surrounding water, hypochlorous acid and hypochlorite ions form as a function of the water's pH. The resulting conversion to the target product is therefore much higher when the pH inside the reactor is low and the reactor wall remains undissolved. With the inclusion of N-succinimide, it is now possible to produce N-chlorosuccinimide with the slow-diffusing chlorine gas. pH buffers can be added to further ensure efficacy based on application requirements. In alkaline pH conditions such as laundry bleaching, the elevated pH will not allow for generation of target products like N-chlorosuccinimide. By sustaining the integrity of the reactor, the internal conditions of the reactor are such that the reactions are successfully carried out. The target product is efficiently generated and released.

Other Components of the Reactor

1) Fillers

Fillers can be used or altogether omitted depending on the type of processing and the requirements of the use of the final product. Fillers are typically inorganic compounds such as various mineral salts, metal oxides, zeolites, clays, aluminates, aluminum sulfate, polyaluminum chloride, polyacrylamide, and the like. Chlorides, carbonates, bicarbonates, oxides, and sulfates of sodium, potassium, lithium, calcium, and magnesium in various combinations may also be used as fillers.

2) pH Buffers

A pH buffer, which is an optional component of the reactor 10, provides a source of pH control within the reactor. Even when alkaline water from laundry wash is used to dissolve the reactants, the pH buffers provide effective adjustment and control of the pH within the desired range to induce the desired reactions inside the reactor. PH buffers can be inorganic (e.g. sodium bisulfate, sodium pyrosulfate, mono-, di-, tri-sodium phosphate, polyphosphates, sodium bicarbonate, sodium carbonate, boric acid, sulfamic acid and the like). Organic buffers are generally organic acids with 1-10 carbons such as succinic acid.

3) Stabilizers

Stabilizers are added when N-hydrogen donors are applied to generate N-halo-imides in-situ. Examples of stabilizers include but are not limited to N-succinimide, N-sulfamate, isocyanuric acid, hydantoin, and the like. When stabilization is not required to generate these compounds, they can be omitted.

4) Cross-Linking Agents

Cross-linking agents, which are additives that change the physical or chemical properties of the composition, may be added to the reactor to control (e.g., reduce) the dissolution rate of the composition. For example, glycoluril is effective at bonding with hydroxyl and carboxylic acid groups such as those found in the cellulose of hydrolysed silicates. Glycerin alters the water permeation rate of polyvinyl alcohol. Therefore, these types of agents can be added or left out depending on the final dissolution rate, hygroscopicity, chemical resistance to oxidizers, etc.

A cross-linking agent is mixed with the binder, and the mixture is combined with the reactants in the manner described above. In cases where curing is required to set the cross-linking agent, the binder and the cross-linking agent are combined in the presence of a solvent and/or a curing agent, mixed, and reacted. If needed, the mixture is dried prior to application (e.g., being combined with the reactants).

The reactor has far-reaching applications. Reactants such as PMPS and NaCl are quite stable when dry but once moisture is added and reactions are triggered, an agent with a completely different set of properties may be produced. The reactor allows for a stable point-of-use product with easy application. The fact that the reaction is triggered by moisture allows for a wide range of applications since the reactor remains stable until some type of liquid, such as water, contacts the composition. The contaminated liquid that is to be treated is what activates the reactor to generate and release target products for treatment. When the released target products are oxidizers, they treat the bulk liquid by controlling bacteria, viruses and various organic and inorganic contaminants.

The benefits of the invention are broad in nature. The reactors are storage stable and provide a safe to use bleaching agents and antimicrobial agents in a ready to use form. This technology greatly enhances the utility of the agents. For example, the agents can be combined with traditional pool water treatments to provide chlorine dioxide or hydroxyl radicals to provide a synergistic effect.

One benefit of the invention is to control the reactor chemistry as to maximize the concentration of reactants in an environment conducive to forming the target products. For example, N-chlorosuccinimide generation is best performed under acidic conditions where chlorine gas and/or hypochlorous acid are readily available. In applications such as laundry bleaching, generation of N-chlorosuccinimide is less than optimal because the alkaline pH (generally >9.0) is not well suited for producing N-chlorosuccinimide. By producing N-chlorosuccinimide in a contained space inside the reactor and controlling the diffusion rate of product and reactants out of the reactor, the conditions that are conducive to high conversion rates and yields are sustained. Thus, the yield is maximized prior to the product's being releasing into the alkaline bleaching environment of the wash-water. Similar characteristics are true of the various oxidizers produced by reacting reagents to generate more powerful oxidants in-situ. Conditions such as pH, concentrations of reactants, and minimizing oxidizer demand such as that found in the bulk wash-water must be controlled to maximize conversion of the reactants and the yield of the target product.

The reactor 10 can be formed into any useful size and shape, including but not limited to a granule, nugget, wafer, disc, briquette, or puck. While the reactor is generally small in size (which is why it is also referred to as the micro-reactor), it is not limited to any size range.

An environmentally protective coating may be formed around the binder layer to prevent the agglomerate composition from premature reaction or decomposition prior to carrying out the function of a reactor. While the foregoing has been with reference to a particular embodiment of the invention, it will be appreciated by those skilled in the art that changes in this embodiment may be made without departing from the principles and spirit of the invention.

What is claimed is:

1. A composition that generates and releases a target product at a controlled rate, the composition comprising:
a reactant capable of generating the target product through a chemical reaction when contacted by a main solvent; and
a binder material in contact with the reactant, wherein the binder material, upon being exposed to the main solvent, forms a solvent-permeable colloidal gel wall that creates a chamber enclosing some of the reactant such that the target product is generated in the chamber, wherein the colloidal gel wall restricts diffusion of the reactant and the target product out of the chamber, and wherein the colloidal gel wall disintegrates when a depletion level is reached inside the chamber;
wherein different parts of the composition are exposed to the main solvent at different times.

2. The composition of claim 1, wherein the composition is subdivided into a plurality of chambers by the colloidal gel wall, each of the chambers enclosing some of the reactants.

3. The composition of claim 1, wherein the reactant dissolves in the main solvent to form a liquid phase reactant before starting the chemical reaction.

4. The composition of claim 1, wherein the target product diffuses out of the chamber in a solution form.

5. The composition of claim 1, wherein the target product is an oxidizing agent.

6. The composition of claim 5, wherein the oxidizing agent is one of chlorine dioxide, dioxirane, hydroxyl radicals, N-halo-amide, percarboxylic acid, hypo-halite, and singlet oxygen.

7. The composition of claim 1, wherein the colloidal gel wall is a first colloidal gel wall formed by a first binder material that is at a different location within the composition than a second binder material, wherein the second binder material is exposed to the main solvent after the first colloidal wall disintegrates, the second binder material forming a second colloidal gel wall after the first colloidal wall disintegrates.

8. The composition of claim 1, wherein the binder material comprises a silicate.

9. The composition of claim 8, wherein the main solvent is water and the silicate is water-soluble.

10. The composition of claim 1, wherein the binder material comprises one of a polysaccharide, water-soluble silicate, aluminum sulfate, polyaluminum chloride, aluminates, polyvinyl alcohol, and an absorbent polymer.

11. The composition of claim 1, wherein the binder material comprises one of a chitosan, chitin, and cellulose.

12. The composition of claim 1 further comprising a filler selected from a group consisting of metal oxides, mineral salts, clays, zeolite, aluminates, aluminum sulfate, polyaluminum chloride, and polyacrylamide.

13. The composition of claim 1 further comprising a cross-linking agent mixed with the binder material to control a dissolution rate of the binder material.

14. A method of producing a composition that releases a target product at a controlled rate, the method comprising:
providing a reactant that generates the target product upon being contacted by a main solvent;
combining the reactant with a binder material to form a mixture; and
applying a pressure to the mixture to form an agglomerate.

15. The method of claim 14, wherein the pressure is between about 1,000 psig and about 10,000 psig.

16. The method of claim 14, wherein the target product is an oxidizing agent.

17. The method of claim 14, wherein the target product is selected from a group consisting of chlorine dioxide, dioxirane, hydroxyl radicals, N-halo-amide, percarboxylic acid, hypo-halite, and singlet oxygen.

18. The method of claim 14 further comprising adding a filler to the mixture, wherein the filler is selected from a group consisting of silicate, silica gel, clay minerals, zeolite, silicon dioxide, fumed silica, silicon oxyhydroxides, aluminum oxide, alumina gel, aluminum oxyhydroxides, aluminates, metal oxides, metal oxyhydroxides, mineral salts, aluminum sulfate, polyaluminum chloride, polyacrylamide, and borax.

19. The method of claim 14 further comprising selecting the binder material from polysaccharide, water-soluble silicate, aluminum sulfate, polyaluminum chloride, aluminates, and an absorbent polymer.

20. The method of claim 14 further comprising selecting the binder material from chitosan, chitin, and cellulose.

21. The method of claim 14 further comprising crushing the agglomerate to produce a desired size.

22. The method of claim 14 further comprising grinding the agglomerate to produce a desired size.

23. The method of claim 14 further comprising selecting the pressure according to a desired rate of target product generation and release.

24. The method of claim 14 further comprising mixing a cross-linking agent with the binder material prior to the combining with the reactant.

25. The method of claim 14 further comprising mixing a cross-linking agent with the binder material and a curing agent prior to the combining with the reactant.

26. A method of producing a composition for generating and releasing a target product, the method comprising:
mixing reactants that, upon being contacted by a main solvent, generate the target product through a chemical reaction;
forming granules with the mixed reactants;
coating the granules with a binder material to form binder-coated granules; and
applying a pressure to the binder-coated granules to create an agglomeration of the binder-coated granules.

27. The method of claim 26, wherein forming the granules comprises using a spray tower.

28. The method of claim 26 further comprising mixing the reactants with a binder material prior to the forming of the granules.

29. The method of claim 28 further comprising mixing a cross-linking agent with the binder material prior to the mixing of the reactants with the binder material.

30. The method of claim 26, wherein forming the granules comprises:
agglomerating the mixed reactants; and
grinding or crushing the agglomeration to produce granules of a desired size.

31. The method of claim 26, wherein between about 1,000 and about 10,000 psig.

32. A composition for generating and releasing chlorine dioxide at a controlled rate, the composition comprising:
reactants including a metal chlorite, an acid source, and a free halogen source, wherein the reactants generate a solution containing chlorine dioxide by a chemical reaction when dissolved in water; and
a binder material in contact with the reactants, wherein the binder material, upon being contacted by water, forms a colloidal gel wall that creates a water-permeable chamber enclosing the reactants such that reactants dissolve and generate chlorine in the chamber, wherein the colloidal gel wall restricts diffusion of the reactants and chlorine dioxide out of the chamber, and wherein the colloidal gel wall disintegrates when a depletion level is reached inside the chamber;
wherein different parts of the composition contact the water at different times.

33. The composition of claim 32, wherein the chlorine dioxide diffuses out of the chamber in the form of an oxidizing solution.

34. The composition of claim 33, wherein the oxidizing solution comprises free halogen.

35. The composition of claim 32, wherein a free halogen concentration in the solution is less than ½ of a chlorine dioxide concentration in the oxidizing solution on a weight basis and a ratio of the chlorine dioxide concentration to a sum of the chlorine dioxide concentration and chlorite anion concentration in the oxidizing solution is at least 0.25:1 by weight.

36. The composition of claim 32, wherein a free halogen concentration in the oxidizing solution is less than ¼ of a chlorine dioxide concentration in the oxidizing solution on a weight basis and a ratio of the chlorine dioxide concentration to a sum of the chlorine dioxide concentration and chlorite anion concentration in the oxidizing solution is at least 0.25:1 by weight.

37. The composition of claim 32, wherein a free halogen concentration in the oxidizing solution is less than 1/10 of a chlorine dioxide concentration in the oxidizing solution on a weight basis and a ratio of the chlorine dioxide concentration to a sum of the chlorine dioxide concentration and chlorite anion concentration in the oxidizing solution is at least 0.25:1 by weight.

38. The composition of claim 32, wherein a ratio of chlorine dioxide concentration to a sum of the chlorine dioxide concentration and chlorite anion concentration in the oxidizing solution is at least 0.60:1 by weight.

39. The composition of claim 32, wherein a ratio of chlorine dioxide concentration to a sum of the chlorine dioxide concentration and chlorite anion concentration in the oxidizing solution is at least 0.75:1 by weight.

40. The composition of claim 32, wherein the composition is soluble in water.

41. The composition of claim 32, wherein the binder material is mixed with a cross-linking agent that controls the binder material's dissolution rate in water.

42. The composition of claim 32, wherein the metal chlorite comprises at least one of sodium chlorite, potassium chlorite, magnesium chlorite, and calcium chlorite.

43. The composition of claim 32, wherein the acid source comprises sodium bisulfate.

44. The composition of claim 32 further comprising magnesium chloride mixed with the reactants and the binder material.

45. The composition of claim 32, wherein the free halogen source comprises a material selected from the group consisting of dichloroisocyanuric acid, a salt of dichloroisocyanuric acid, a hydrated salt of dichloroisocyanuric acid, trichlorocyanuric acid, a salt of hypochlorous acid, bromochlorodimethylhydantoin and dibromodimethylhydantoin.

46. The composition of claim 32, wherein the source of free halogen comprises a sodium salt of dichloroisocyanuric acid.

47. The composition of claim 32, wherein the free halogen source comprises a sodium salt of dichloroisocyanuric acid dihydrate.

48. The composition of claim 32, wherein the free halogen source is selected from a group consisting of: magnesium chloride, calcium chloride, sodium chloride, and potassium chloride.

49. The composition of claim 32, wherein the halogen source is the same as the metal chlorite.

50. The composition of claim 32, wherein the reactants comprise sodium chlorite, sodium bisulfate, calcium chloride and the sodium salt of dichloroisocyanuric acid dihydrate.

51. The composition of claim 32, wherein the metal chloride is sodium chlorite, the acid source is sodium bisulfate, and the free halogen source is a sodium salt of dichloroisocyanuric acid dehydrate, further comprising magnesium chloride.

52. The composition of claim 32, wherein the metal chlorite is sodium chlorite, the acid source is sodium bisulfate, and the free halogen source is a sodium salt of dichloro-isocyanuric acid dehydrate, further comprising sodium bicarbonate and magnesium chloride.

53. The composition of claim 32 further comprising a protective layer deposited on an outer surface of the composition.

54. The composition of claim 53, wherein the protective layer is selected from a group consisting of silicates, polysiloxane, polysaccharides, polymers, and mineral salts.

55. A composition for generating and releasing chlorine dioxide at controlled rate the composition comprising:
reactants including a metal chlorite and an acid source, wherein the reactants chemically react to generate an oxidizing solution containing chlorine dioxide upon being contacted by water; and
a binder material in contact with the reactants, wherein the binder material, upon being contacted by water, forms a colloidal gel wall that creates a chamber enclosing the reactants such that chlorine dioxide is generated in the chamber while the colloidal gel wall restricts diffusion of the reactants and chlorine dioxide out of the chamber, and wherein the colloidal gel wall disintegrates when a depletion level is reached inside the chamber;
wherein different parts of the composition contacts water at different times.

56. The composition of claim 55, wherein the metal chlorite is sodium chlorite.

57. The composition of claim 55, wherein the acid source is selected from a group consisting of a metal bisulfate, a metal pyrosulfate, and a metal phosphate.

58. The composition of claim 55, wherein the acid source is potassium monopersulfate.

59. The composition of claim 55, wherein the binder material comprises one of a polysaccharide, water-soluble silicate, aluminum sulfate, polyaluminum chloride, aluminates, polyvinyl alcohol, and an absorbent polymer.

60. The composition of claim 55, wherein the binder material comprises one of a chitosan, chitin, and cellulose.

61. The composition of claim 55, wherein the reactants chemically react after dissolving in the water.

62. The composition of claim 55, wherein the binder material is mixed with a cross-linking agent that controls a dissolution rate of the binder material in water.

63. A composition for generating and releasing hydroxyl radicals at a controlled rate, the composition comprising:
reactants including a peroxide donor, an acid source, and a transition metal catalyst that generate hydroxyl radicals through a chemical reaction when contacted by water; and
a binder material in contact with the reactants, wherein the binder material, upon being contacted by water, forms a colloidal gel wall that creates a chamber enclosing the reactants such that hydroxyl radicals are generated in the chamber while the colloidal gel wall restricts diffusion of the reactants and the hydroxyl radicals out of the chamber, and wherein the colloidal gel wall disintegrates when a depletion level is reached inside the chamber.

64. The composition of claim 63, wherein the binder material forms a plurality of chambers, each of the chambers containing some of the reactants.

65. The composition of claim 63, wherein the chamber is a first colloidal gel chamber, wherein a second colloidal gel chamber forms after the first colloidal gel chamber dissipates and exposes dry binder material to the water.

66. The composition of claim 63, wherein the peroxide donor is selected from a group consisting of: sodium, potassium, calcium, magnesium peroxide, sodium, potassium percarbonate or perborate.

67. The composition of claim 63, wherein the transition metal is selected from a group consisting of Cu (II), Mn (II), Co (II), Fe (II), Fe (III), Ni (II), Ti (IV), Mo (V), Mo (VI), W (VI), Ru (III), and Ru (IV).

68. The composition of claim 63 further comprising a chelant.

69. The composition of claim 63, wherein the acid source is a metal bisulfate, pyrosulfate, phosphate, and monopersulfate.

70. The composition of claim 63, wherein the reactants start the chemical reaction after dissolving in the water.
